(19) United States
(12) Patent Application Publication
(10) Pub. No.: US 2013/0124594 A1
(43) Pub. Date: May 16, 2013

(54) DIVIDER CIRCUITRY WITH QUOTIENT PREDICTION BASED ON ESTIMATED PARTIAL REMAINDER

(71) Applicants: Prakash Krishnamoorthy, Bethlehem, PA (US); Ramesh C. Tekumalla, Breinigsville, PA (US)

(72) Inventors: Prakash Krishnamoorthy, Bethlehem, PA (US); Ramesh C. Tekumalla, Breinigsville, PA (US)

(73) Assignee: LSI Corporation, Milpitas, CA (US)

(21) Appl. No.: 13/296,754

(22) Filed: Nov. 15, 2011

(51) Int. Cl. G06F 7/52

(52) U.S. Cl. 708/653; 708/650

(57) ABSTRACT

An integrated circuit comprises divider circuitry configured to perform a division operation. The divider circuitry may be part of an arithmetic logic unit or other computational unit of a microprocessor, digital signal processor, or other type of processor. The divider circuitry iteratively determines bits of a quotient over multiple stages of computation. In determining the quotient in one embodiment, the divider circuitry is configured to estimate a partial remainder for a given one of the stages and to predict one or more of the quotient bits for one or more subsequent stages based on the estimated partial remainder so as to allow one or more computations to be skipped for said one or more subsequent stages, thereby reducing power consumption. The integrated circuit may be incorporated in a computer, a mobile telephone, a storage device or other type of processing device.

### BACKGROUND

Division is one of the fundamental arithmetic operations performed in microprocessors, digital signal processors, and other types of processors. By way of example, such processors may be configured to perform integer division as well as floating-point division. Integer division typically takes more clock cycles to perform than floating-point division, including double precision floating-point division. Furthermore, the number of clock cycles required for integer division can vary depending on the operand values.

As a result, the power consumption associated with performance of integer division operations using conventional circuitry may in some cases be excessive and unpredictable. This can lead to a variety of related issues in the corresponding processors, as well as the computers, mobile telephones and other processing devices in which such processors are incorporated, including reduced battery life, power dissipation that approaches package thermal limits, and power supply regulator performance degradation.

### SUMMARY

One or more illustrative embodiments of the invention provide improved divider circuitry in which power consumption is reduced by performing quotient prediction based on estimated partial remainders. Such divider circuitry can be implemented, by way of example, in an arithmetic logic unit (ALU) of a microprocessor or other type of processor, or in read channel circuitry of a storage device.

In one embodiment of the invention, an integrated circuit comprises divider circuitry configured to perform a division operation. The divider circuitry iteratively determines bits of a quotient over multiple stages of computation. The divider circuitry is configured to estimate a partial remainder for a given one of the stages and to predict one or more of the quotient bits for one or more subsequent stages based on the estimated partial remainder so as to allow one or more computations to be skipped for said one or more subsequent stages. This reduces the power consumption in the divider circuitry relative to that which would otherwise be required if the computations were not skipped. The integrated circuit may be incorporated into a computer, a mobile telephone, a storage device or other type of processing device.

### BRIEF DESCRIPTION OF THE DRAWINGS

FIG. 1 is a block diagram of a data processing system comprising a plurality of processing devices with at least one such processing device comprising a processor having divider circuitry in an illustrative embodiment.

FIG. 2 is a flow diagram of a modified non-restoring integer division algorithm implemented by the divider circuitry of the data processing system of FIG. 1 in an illustrative embodiment.

FIGS. 3A, 3B, 3C and 3D show more detailed views of portions of the divider circuitry of the data processing system of FIG. 1 in an illustrative embodiment. These figures may be collectively referred to herein as FIG. 3.

FIG. 4 is a block diagram of a data processing system comprising a storage device that incorporates the divider circuitry of FIG. 3 in an illustrative embodiment.

### DETAILED DESCRIPTION

Embodiments of the invention will be illustrated herein in conjunction with exemplary data processing systems and associated divider circuitry and division algorithms. It should be understood, however, that embodiments of the invention are more generally applicable to any circuitry-implemented arithmetic operations that include division, such as integer division and floating point division, as well as related arithmetic operations such as computation of square roots and cube roots.

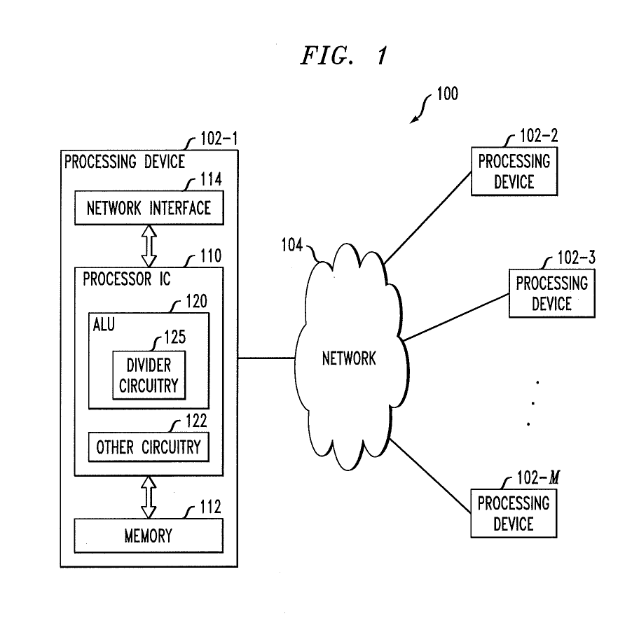

FIG. 1 shows an embodiment of the invention in which a data processing system 100 comprises a plurality of processing devices 102-1, 102-2, . . . 102-M that communicate over a network 104. Processing device 102-1 is shown in greater detail as comprising a processor integrated circuit 110, a memory 112 and a network interface 114, and one or more of the remaining processing devices 102-2 through 102-M may each be assumed to be configured in a similar manner. The processor integrated circuit 110 is coupled to the memory 112 and the network interface 114, and further comprises an ALU 120 and other circuitry 122. The other circuitry 122 may comprise, for example, non-ALU portions of a central processing unit (CPU) of the processor, internal processor memory, as well as other types of internal processor circuitry, in any combination.

The ALU 110 further comprises divider circuitry 125 configured to perform division operations. As will be described in greater detail below, the divider circuitry 125 in this embodiment iteratively determines bits of a quotient over multiple stages of computation, and is configured to estimate a partial remainder for a given one of the stages and to predict one or more of the quotient bits for one or more subsequent stages based on the estimated partial remainder so as to allow one or more computations to be skipped for the one or more subsequent stages.

The particular configuration of data processing system 100 as shown in FIG. 1 is exemplary only, and the system 100 in other embodiments may include other elements in addition to or in place of those specifically shown, including one or more elements of a type commonly found in a conventional implementation of such a system. For example, the processor integrated circuit 110 may comprise, by way of illustration only and without limitation, a microprocessor, a digital signal processor, an application-specific integrated circuit (ASIC), a field-programmable gate array (FPGA), or other type of data processing device, as well as portions or combinations of these and other devices.

Also, the divider circuitry 125 can be implemented in a wide variety of different types of data processing systems. Another embodiment of such a system, comprising a data storage device that incorporates divider circuitry 125, will be described in greater detail below in conjunction with FIG. 4.

The divider circuitry 125 in one embodiment is configured to implement an integer division algorithm. The algorithm may be viewed as an example of what is more generally referred to herein as a modified non-restoring integer division algorithm. It allows division operations to be performed by the divider circuitry 125 at lower power consumption relative to a non-restoring integer division algorithm without the modification. More particularly, the modified algorithm utilizes an estimate of the partial remainder at a given stage in the computation process to predict the quotient bits for a certain number of subsequent stages, thereby allowing computations to be skipped for those stages such that power consumption is reduced. Such an arrangement also serves to speed up the computation process for division operations.

In this embodiment, a division operation may be characterized as

N=Q·D+R (1)

where N is the dividend, Q is the quotient, D is the divisor and R is the remainder. An exemplary non-restoring division algorithm without the above-noted modification for skipping of stages may comprise the following process in which bits of a quotient are iteratively determined over multiple stages of computation:

Initialization: Quotient Q₀=0 and partial remainder R₀=2^{-N+1}−D.

Computation: For 0≦i<n recursively compute

$$\begin{matrix}{R}_{i + 1} = \{ \begin{matrix}2 {R}_{i} - D & if {R}_{i} \geq 0 , \\ 2 {R}_{i} + D & otherwise .\end{matrix} & ( 2 ) \\ {Q}_{i + 1} = \{ \begin{matrix}2 {Q}_{i} + 1 & if {R}_{i} \geq 0 , \\ 2 {Q}_{i} & otherwise .\end{matrix} & ( 3 )\end{matrix}$$

In the above process, at least one addition or subtraction operation is required at each stage of the iterative computation in order to update the partial remainder and predict a single bit of the quotient. However, we have determined that if at any stage the magnitude of the partial remainder is small compared with the divisor, then we can predict the quotient bits and the partial remainder for several subsequent stages at once.

The divider circuitry 125 in the present embodiment may therefore be configured to determine, for a given stage of the computation, a particular number of subsequent stages for which computations may be skipped, as a function of an estimated partial remainder relative to a divisor. The partial remainder is estimated in this embodiment based on one or more of its most significant bits, which provides additional simplification relative to utilizing the entire partial remainder itself.

By way of example, assume that the partial remainder for stage i is denoted Rᵢ and further assume that t denotes the number of leading bits of Rᵢ that are identical, that is, have the same logic value. We have determined that if t≧2, then t-1 bits of the quotient can be predicted by the divider circuitry 125. In such an arrangement, if the t leading bits of Rᵢ are 0, then the t-1 predicted bits of the quotient may be predicted as a 1 followed by at least one 0, and if the t leading bits of Rᵢ are 1, then the t-1 predicted bits of the quotient may be given by a 0 followed by at least one 1. Thus, if the leading bits of the partial remainder Rᵢ are 0, then the t-1 predicted bits of the quotient are 100 . . . and if the leading bits are 1, then the predicted quotient bits are 011 . . . .

The correctness of this prediction can be shown as follows, using Case 1 for positive partial remainders and Case 2 for negative partial remainders.

Case 1: Rᵢ≧0

Note that since Rᵢ has t leading 0 bits, 0≦2^{t-1}Rᵢ<2ⁿ, and since D is normalized, D≧2ⁿ⁻¹. Accordingly,

0≦2^{t-1}Rᵢ<2D (4)

The predicted t-1 bit quotient string 100 . . . would be correct if and only if the resultant Rᵢ₊ₜ₋₁ satisfies −D≦Rᵢ₊ₜ₋₁<D. It is apparent that

Rᵢ₊ₜ₋₁=2^{t-1}Rᵢ−D (5)

Subtracting D from both sides of the inequality results in the proper bound on Rᵢ₊ₜ₋₁.

Case 2: Rᵢ<0

In this case, Rᵢ has t leading 1 bits giving −2ⁿ≦2^{t-1}Rᵢ<0. Combining this with the bound on D gives

−2D≦2^{t-1}Rᵢ<0 (6)

The predicted t-1 bit quotient string 011 . . . would be correct if and only if the resultant Rᵢ₊₁₋₁ satisfies −D<Rᵢ₊ₜ₋₁<D. Now,

Rᵢ₊ₜ₋₁=2^{t-1}Rᵢ+D (7)

Adding D to both sides of the inequality results in the proper bound on Rᵢ₊ₜ₋₁.

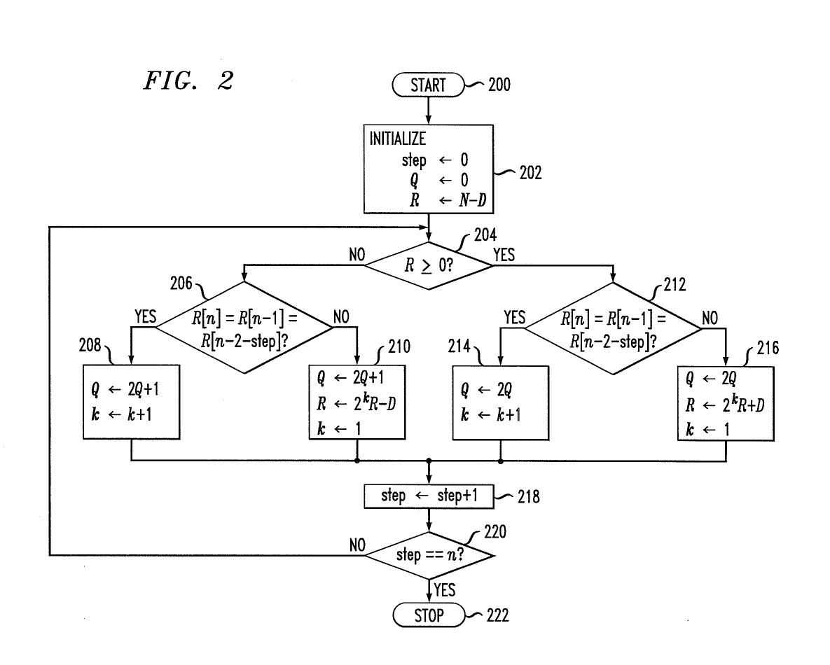

Referring now to FIG. 2, a flow diagram of an exemplary modified non-restoring integer division algorithm implemented by the divider circuitry 125 is shown. The flow diagram includes blocks 200 through 222. In this embodiment, the partial remainder is estimated for a given stage based on two most significant bits of the partial remainder and an additional bit of the partial remainder which is selecting depending on the given stage. When the two most significant bits and the additional bit of the partial remainder are all 1 or all 0, computations are skipped for at least two subsequent stages.

The modified non-restoring integer division algorithm in this embodiment is started in block 200 and proceeds to initialization in block 202. For purposes of the FIG. 2 diagram, the computation stages previously referred to above are more particularly referred to as “steps” and range from 0 to n, and the partial remainder at a particular step n may be denoted as R[n] or as simply R when the step is understood from the context. In the initialization block 202, the step is set to 0, the quotient Q is set to 0, and the remainder partial remainder R is set to N-D. Other variables such as k may also be initialized.

A determination is then made in block 204 as to whether R is positive or negative. If R is less than zero, the algorithm proceeds down the left branch to block 206, and otherwise the algorithm proceeds down the right branch to block 212.

As indicated previously, the partial remainder is estimated for a given stage based on the two most significant bits of the partial remainder, denoted R[n] and R[n−1] in block 206 and 212, and an additional bit of the partial remainder, denoted R[n−2-step] in blocks 206 and 212, which is selected depending on the current step value.

If R<0 and it is determined in block 206 that all of the bits R[n], R[n−1] and R[n−2-step] are equal, the process moves to block 208, in which Q is predicted as 2Q+1 and a skip counter k is incremented by 1, but the partial remainder R is unchanged. Otherwise, the process moves to block 210, in which Q is predicted as 2Q+1, the partial remainder R is updated based on the skip counter k to 2^{k}R−D, and then the skip counter k is reset to 1. After either block 208 or block 210, the step value is incremented in block 218. If the incremented step value is determined to be equal to n in block 220, the algorithm ends as indicated in block 222, and otherwise returns to block 204 as indicated.

Thus, if the determination in block 206 is yes, the quotient is updated without making any changes to the partial remainder and the algorithm proceeds back to block 204 and then to block 206 to evaluate the next set of bits R[n], R[n−1] and R[n−2-step] at the new step value for the updated quotient. No further quotient prediction is possible when any one of these bits does not match the others, in which case block 210 is executed.

The operation of the right branch of the algorithm is similar to that of the left branch as described above, starting with block 212. Accordingly, if R≧0 and it is determined in block 212 that all of the bits R[n], R[n−1] and R[n−2-step] are equal, the process moves to block 214, in which Q is predicted as 2Q and the skip counter k is incremented by 1, but the partial remainder R is unchanged. Otherwise, the process moves to block 216, in which Q is predicted as 2Q, the partial remainder R is updated based on the skip counter k to 2^{k}R+D, and then the skip counter k is reset to 1. After either block 214 or block 216, the step value is incremented in block 218. If the incremented step value is determined to be equal to n in block 220, the algorithm ends as indicated in block 222, and otherwise returns to block 204 as indicated.

Thus, if the determination in block 212 is yes, the quotient is updated without making any changes to the partial remainder and the algorithm proceeds back to block 204 and then to block 212 to evaluate the next set of bits R[n], R[n−1] and R[n−2-step] at the new step value for the updated quotient. No further quotient prediction is possible when any one of these bits does not match the others, in which case block 216 is executed.

It should be noted that the particular division algorithm shown in FIG. 2 is presented by way of illustration only, and other types of algorithms can be used in other embodiments of the invention. For example, the computation skipping techniques disclosed herein can be adapted to any iterative algorithm, including Newton-Raphson algorithms as well as other types of iterative algorithms. The particular bits of the partial remainder to be examined will generally vary depending upon the algorithm, and a complex function of these bits may be used in a given embodiment. Additional details on other division algorithms that may be modified in accordance with embodiments of the invention are described in, for example, M.D. Ercegovac et al., “Division and Square Root Recurrence Algorithms and Implementations,” Kluwer Academic Publishers, 1994.

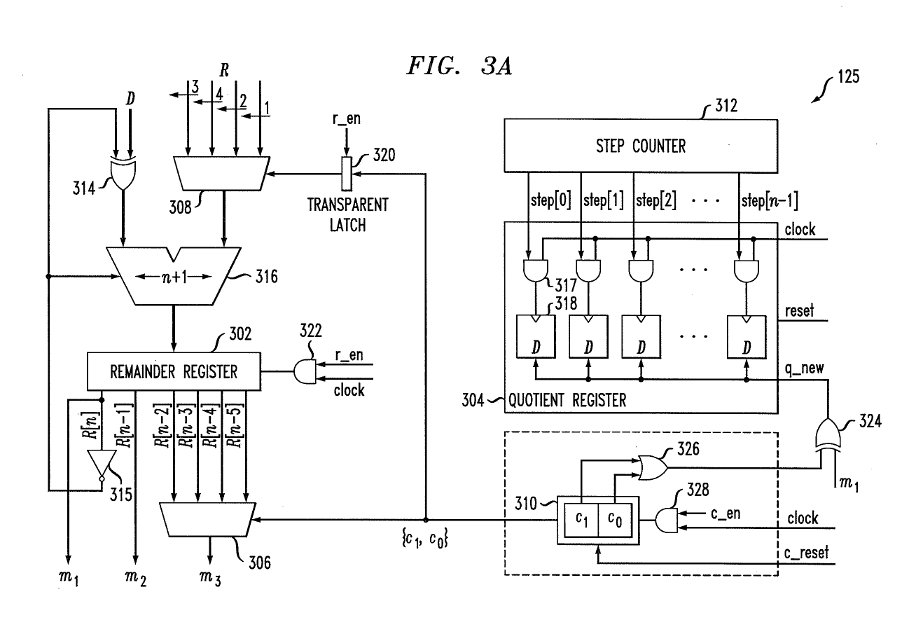

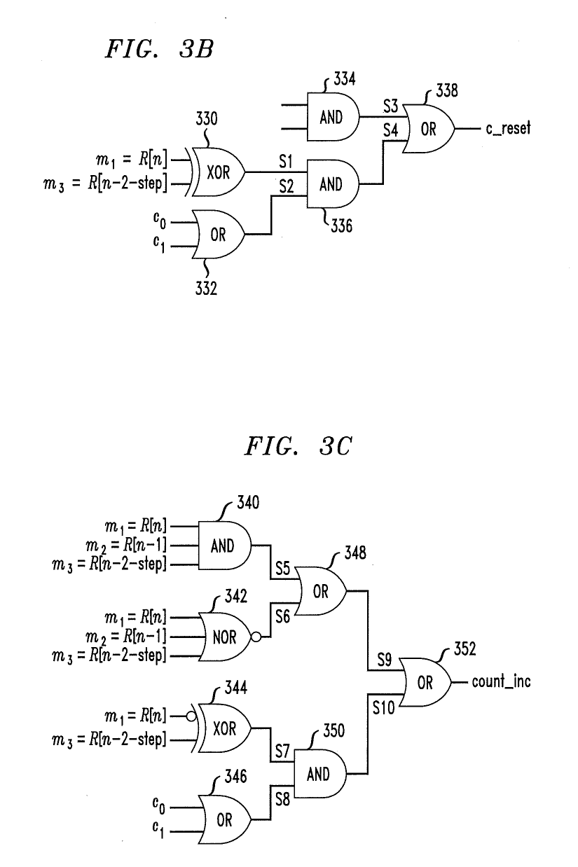

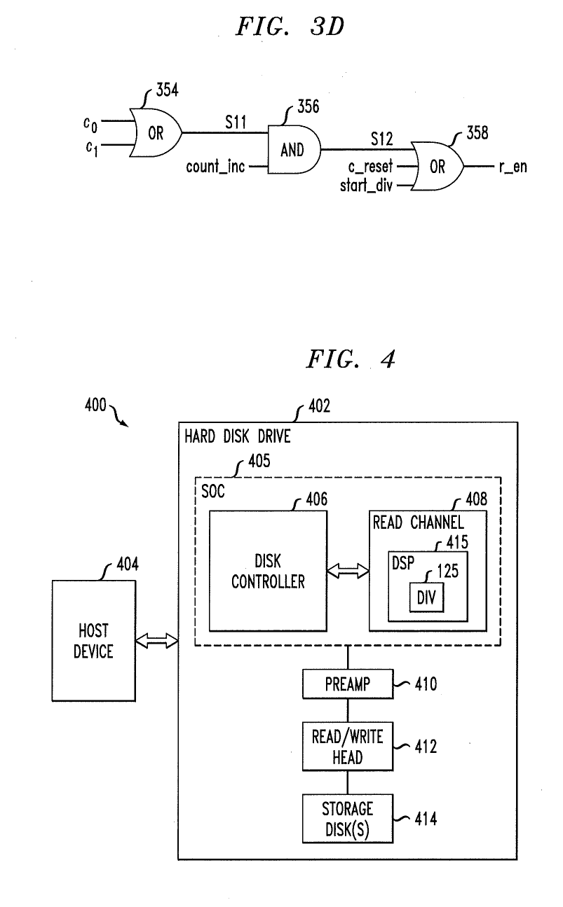

The exemplary modified non-restoring integer division algorithm described above in the context of FIG. 2 can be adapted to skip computations for any number of stages. An embodiment more particularly configured to skip at least one addition or subtraction computation for each of up to four stages will now be described with reference to FIG. 3. As illustrated in FIG. 3A, the divider circuitry 125 implements the modified non-restoring integer division algorithm of FIG. 2 to predict n bits of the quotient, given the divisor D and the dividend N, each of which are also assumed to be n-bit values, in a manner that allows at least one computation to be skipped for each of up to four stages. At each stage, the partial remainder R is stored in a remainder register 302 and the quotient Q is stored in a quotient register 304. The remainder register is n+1 bits wide, in accordance with the previously-described bounds −D≦Rᵢ≦D and D<2ⁿ.

With continued reference to FIG. 3A, the divider circuitry 125 in this embodiment further comprises a first multiplexer 306, a second multiplexer 308, a first counter 310 and a second counter 312. The first counter 310 serves as the above-noted skip counter generating the skip count value k, and in this embodiment comprises a two-bit counter that tracks a number of stages, up to a maximum of four stages, for which computations are skipped. As indicated previously, the number of stages for which computations can be skipped is determined based on the two most significant bit outputs R[n] and R[n−1] of the remainder register 302 and another selected lower order bit output R[n−2-step] of the remainder register 302. Corresponding values are denoted m₁, m₂ and m₃, respectively, in the divider circuitry 125.

The first multiplexer 306 is configured to select as the value m₃ a particular one of a plurality of lower order bit outputs of the remainder register 302 responsive to a first count signal comprising bits c₁ and c₀ from the first counter 310. The second multiplexer 308 is configured to select a particular shifted version of outputs of the remainder register 302, also responsive to the first count signal from the first counter 310.

The first counter 310 in this embodiment is implemented as a Gray code counter that tracks the number of consecutive stages for which at least one addition or subtraction operation is skipped. As noted above, such skipping of computations in the present embodiment occurs when the estimated partial remainder is small relative to the divisor.

The second counter 312 is a step counter that keeps track of the current step of the division algorithm. The step value that it generates is utilized to select a particular bit position of the quotient register 304 for updating to a predicted value in a corresponding one of the computation stages.

Also included in the divider circuitry 125 is an exclusive-or (XOR) gate 314 having a first input adapted to receive the divisor D and a second input coupled to the most significant bit output m₁ of the remainder register 302 via an inverter 315. The second input of the XOR gate 314 therefore receives the complement of m₁. The output of the XOR gate 314 is provided to one input of an n+1 bit adder 316. The other input of the adder 316 is coupled to an output of the second multiplexer 308. The output of the adder 316 provides the current partial remainder for storage in the remainder register 302.

The quotient register 304 comprises for each of the n bits of the quotient a corresponding AND gate 317 and flip-flop 318. Each AND gate 317 has one of its inputs driven by a corresponding one of the bits step [0], step[1], step[2] . . . step [n−1] of the step value provided by the step counter 312, and its other input driven by a clock signal. The output of each AND gate 317 is provided to a clock input of the corresponding flip-flop 318.

The quotient register 304 in the present embodiment is therefore configured to include a set of individual flip-flops 318 each controlled by a signal from the step counter 312. The step counter sequence is configured such that it produces one logic transition at every step of the division algorithm. The step value output bits of the step counter 312 are used as gating signals for the quotient register 304 via respective ones of the AND gates 317. This ensures that only the individual quotient bit predicted for a particular step is updated in the quotient register 304 for that step. The update input signal is denoted q_new, and is applied to data inputs of each of the flip-flops 318. The quotient register can be reset by an applied reset signal, as indicated in the figure.

A transparent latch 320 is coupled between an output of the first counter 310 and a select line input of the second multiplexer 308. The transparent latch is controlled by a remainder register enable signal r_en. This signal r_en also gates the clock signal applied to the remainder register 302, via AND gate 322. As a result, the remainder register 302 is clocked only when the signal r_en is enabled.

Updating of the selected bit position of the quotient Q is performed in quotient register 304 as a function of the first count signal from the first counter and the most significant bit output m₁ of the remainder register 302. More particularly, the output m₁ is applied to one input of an XOR gate 324 that has an output driving the data inputs of the flip-flops 318. The two bits c₁ and c₀ of the counter 310 are applied to inputs of an OR gate 326 and the resulting output drives the other input of the XOR gate 324. The clock signal applied to counter 310 is gated by an AND gate 328 based on a counter enable signal c_en. The counter 310 is reset using a counter reset signal c_reset.

The partial remainder bits R[n], R[n−1] and R[n−2-step]corresponding to respective signals m₁, m₂ and m₃ are utilized in the magnitude comparison process in the following manner. First, if m₁=m₂=m₃=1, then we have a case where the magnitude of R is small compared to D and at least one more bit of the quotient can be predicted apart from the current predicted bit of the quotient. When this condition occurs, the skip counter 310 increments by one, and one bit of the quotient register 304 is updated. The contents of the remainder register 302 remain unaltered, by disabling the r_en signal.

If the remainder register were to be updated in every step, then we would have to examine the same bit positions to see if there is any opportunity to skip any updates to the partial remainder. However, since the contents of the remainder register 302 remain unchanged when the divider circuitry is in a prediction sequence, we need to examine the bit positions R[i-1], R[i-2], R[i-3] if we examined R[i], R[i-1], R[i-2] in the previous step of the algorithm. Accordingly, we need to examine only a single bit to the right of the last bit that was examined in the previous step. This is accomplished by the first multiplexer 306 which generates the signal m₃. The first multiplexer 306 taps the bit position R[n−2] when the divider circuitry is in a non-prediction sequence, and taps successive bit positions to the right for successive steps when the divider circuitry is in a prediction sequence. The bit position to tap is controlled by the current count of the skip counter 310.

The second multiplexer 308 at the input of the adder 316 prepares the appropriate operands that need to be fed to the adder during either a non-prediction sequence or at the end of a prediction sequence. Since operands are generated only at these times, the current count of the skip counter 310 is passed through the transparent latch 320 controlled by the same r_en signal that gates the clocking of the remainder register 302.

The second multiplexer 308 is configured to perform a selection that is equivalent to a designated bit shifting operation. For example, the right-most input of the multiplexer 308 corresponds to a left shift of one bit position, which is equivalent to multiplication by two. Similarly, the next adjacent input of multiplexer 308 corresponds to a left shift of two bit positions, which is equivalent to multiplication by four. No actual shift is implemented, but bit positions corresponding to the shift are selected. Thus, for example, if R=011001, then the left shift of R is 110010, which can be achieved by ignoring the most significant bit and selecting all of the bits to the right of the most significant bit. For two left shifts, we ignore the two most significant bits and pick all other bits to the right of the two most significant bits. Accordingly, the multiplexer 308 implements a bit selection process that is equivalent to corresponding left shifts of R. Because a Gray code is used for the skip counter in this embodiment, the inputs of the multiplexer 308 are arranged in Gray code sequential order, such that 1-bit, 2-bit, 3-bit and 4-bit shifts are selected given mux select input bits of 00, 01, 11 and 10, respectively, supplied from counter 310 via latch 320.

Additional circuitry utilized to generate signals in the divider circuitry 125 is shown in FIGS. 3B, 3C and 3D.

The circuitry of FIG. 3B comprises XOR gate 330, OR gate 332, AND gates 334 and 336, and OR gate 338. The XOR gate 330 receives as its inputs the partial remainder bits R[n] and R[n−2-step], which correspond to signals m₁ and m₃, respectively. The OR gate 332 and the AND gate 334 both receive as their inputs the bits c₁ and c₀ from skip counter 310. The AND gate 336 receives as its inputs the outputs S1 and S2 from gates 330 and 332, respectively. The OR gate 338 receives as its inputs the outputs S3 and S4 from gates 334 and 336, respectively. The output of OR gate 338 is the skip counter reset signal c_reset.

The circuitry of FIG. 3C comprises AND gate 340 and NOR gate 342, both of which receive as their inputs the partial remainder bits R[n], R[n−1] and R[n−2-step], which correspond to signals m₁, m₂ and m₃, respectively. The circuitry further comprises XOR gate 344, OR gates 346 and 348, AND gate 350, and OR gate 352. The XOR gate 344 receives as its inputs R[n−2-step] and the inverse of R[n]. The OR gate 346 receives as its inputs the bits c₁ and c₀ from skip counter 310. The OR gate 348 receives as its inputs the outputs S5 and S6 from gates 340 and 342, respectively. The AND gate 350 receives as its inputs the outputs S7 and S8 from gates 344 and 346, respectively. The OR gate 352 receives as its inputs the outputs S9 and S10 from gates 348 and 350, respectively. The output of OR gate 352 is an intermediate counter increment signal count_inc.

The circuitry of FIG. 3D comprises OR gate 354 which receives as its inputs the bits c₁ and c₀ from skip counter 310, AND gate 356 which receives as its inputs the increment signal count_inc and the output S11 of gate 354, and OR gate 358 which receives as its input the reset signal c_reset, a divider start signal start_div and the output S12 of gate 356. The output of OR gate 358 is the register enable signal r_en.

The additional circuitry of FIGS. 3B through 3D generally implements logic equations (8)-(22) below for providing the signals r_en and c_reset of FIG. 3A, as well as the intermediate counter increment signal denoted count_inc. The circuitry makes use of the divider start signal denoted start_div. The symbols [symbol] , [symbol] and [symbol] denote logical AND, OR and XOR operators, respectively.

S1=R[n] [symbol] R[n−2-step] (8)

S2=c₀ [symbol] c₁ (9)

S3=c₀ [symbol] c₁ (10)

S4=S1 [symbol] S2 (11)

c_reset=S3 [symbol] S4 (12)

S5=R[n] [symbol] R[n−1 [symbol] ]R[n−2-step] (13)

$$S 6 = \overline{R [ n ] R [ n - 2 - step ] } \qquad ( 14 )$$

S7= R̅[̅n̅]̅ [symbol] R[n−2-step] (15)

S8=c₀ [symbol] c₁ (16)

S9=S5 [symbol] S6 (17)

S10=S7 [symbol] S8 (18)

count_{—}inc=S9 [symbol] S10 (19)

S11=c₀ [symbol] c₁ (20)

S12=S11 [symbol] count_inc (21)

r_en=S12 [symbol] c_reset [symbol] start_div (22)

The divider circuitry 125 as illustrated in the FIG. 3 embodiment exhibits a substantially lower number of addition or subtraction computations than a non-restoring integer divider without the computation skipping functionality described above. For example, with implementations having 23-bit operands and a quotient computed at up to 23 bits of precision, an average reduction in the number of addition or subtraction computations of about 50% is achieved using the 4-bit prediction length of FIG. 3. For longer prediction lengths of 8, 16 and 23 bits, the average reduction in addition or subtraction computations is about 60%. In addition, the use of a Gray code counter and associated circuitry such as transparent latch 320 serves to reduce spurious combinational activity in the adder 316. Sequential activity is reduced in other portions of the divider circuitry 125 through the use of clock gating via AND gates 317, 322 and 328.

It is to be appreciated that the particular divider circuitry shown in FIG. 3 is presented by way of illustrative example only, and numerous alternative arrangements of circuit elements may be used to provide an integer divider or other divider with computation skipping functionality of the type disclosed herein.

For example, in another embodiment, the multiplexers 306 and 308 can be implemented as respective two-input multiplexers, and yet computations can still be skipped for any number of stages. Such an embodiment may be particularly desirable if the maximum number of stages for which computations can be skipped is large, but use of large multiplexers is not appropriate for the corresponding application.

In this embodiment, one of the inputs to the two-input version of multiplexer 308 will be the value of R left shifted by one position, and the other input will be the value of a new register referred to as R′. In blocks 210 and 216 in FIG. 2, and if k>1, the two-input version of multiplexer 308 will select R′, and otherwise will select R. The register R′ is updated in blocks 208 and 214 by assigning R′=2R′, which represents a single left shift of R′. For the blocks 210 and 216, we assign R′=2R. This represents a single left shift of R, so after k skips, R′ will be 2^{k}R. For this embodiment, the transparent latch 320 is placed at the output of the two-input version of multiplexer 308, thereby allowing the contents to feed into the adder 316. Also, the two-input version of multiplexer 306 is modified such that when skipping, m₃ will be the third most significant bit of R′. When not skipping, m₃ will be the third most significant bit of R, as in the FIG. 3 embodiment. Since R′ is constantly shifted left, m₃ is extracted out at the right bit position. Skipping implies the execution of block 208 or 214 in FIG. 2. There is no change to the m₁ and m₂ signals relative to the FIG. 3 embodiment. Again, this is just one illustrative embodiment, and numerous alternative circuitry arrangements may be used.

As indicated previously, divider circuitry 125 can be implemented in a wide variety of different types of data processing systems. Another embodiment of such a system is the data processing system 400 shown in FIG. 4. This system comprises a hard disk drive (HDD) 402 coupled to a host device 404. The HDD 402 comprises a system-on-chip (SOC) integrated circuit 405 comprising a disk controller 406 coupled to read channel circuitry 408. The SOC 405 communicates via a preamplifier 410 with a read/write head 412 in order to write data to and read data from one or more storage disks 414. The read channel circuitry 408 includes a digital signal processor (DSP) 415 that comprises, in addition to other digital computation elements not expressly shown, divider circuitry 125 of the type previously described. The host device 404 may comprise, for example, a computer or other processing device that is coupled to or incorporates the HDD 402. Such a processing device may comprise processor and memory elements used to execute software code.

It should be noted that the term “divider circuitry” as used herein is intended to be generally construed so as to encompass processor circuitry that implements division operations at least in part in the form of software that is executed in the processor. For example, at least a portion of the division algorithm of FIG. 2 may be implemented in the form of software that is stored in a memory such as memory 112 or an internal memory of processor 110 in the FIG. 1 embodiment, or in a memory of the SOC 405 in the FIG. 4 embodiment. A given such memory that stores software code for execution by a corresponding processor is an example of what is more generally referred to herein as a computer-readable medium or other type of computer program product having computer program code embodied therein, and may comprise, for example, electronic memory such as RAM or ROM, magnetic memory, optical memory, or other types of storage devices in any combination. The processor may comprise a microprocessor, CPU, ASIC, FPGA or other type of processing device, as well as portions or combinations of such devices. Although not expressly shown in FIG. 4, such a processor may be implemented in the SOC 405, or in another part of the HDD 402.

As indicated above, embodiments of the invention may be implemented in the form of integrated circuits. In a given such integrated circuit implementation, identical die are typically formed in a repeated pattern on a surface of a semiconductor wafer. Each die includes divider circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Again, it should be emphasized that the embodiments of the invention as described herein are intended to be illustrative only. For example, other embodiments of the invention can be implemented using a wide variety of other types of divider circuitry and associated division algorithms, than those included in the embodiments described herein. These and numerous other alternative embodiments within the scope of the following claims will be readily apparent to those skilled in the art.

What is claimed is:

1. An integrated circuit comprising:
divider circuitry configured to perform a division operation;
wherein said divider circuitry iteratively determines bits of a quotient over multiple stages of computation; and
wherein said divider circuitry is configured to estimate a partial remainder for a given one of the stages and to predict one or more of the quotient bits for one or more subsequent stages based on the estimated partial remainder so as to allow one or more computations to be skipped for said one or more subsequent stages.

2. The integrated circuit of claim 1 wherein the divider circuitry determines a number of subsequent stages for which computations may be skipped as a function of the estimated partial remainder relative to a divisor.

3. The integrated circuit of claim 1 wherein the partial remainder is estimated based on at least one most significant bit of said partial remainder.

4. The integrated circuit of claim 3 wherein the partial remainder for stage i is denoted Rᵢ and t denotes the number of leading bits of Rᵢ having the same logic value, and further wherein if t≧2 then t-1 bits of the quotient are predicted by the divider circuitry.

5. The integrated circuit of claim 4 wherein if the t leading bits of Rᵢ are all logic 0 bits, then the t-1 predicted bits of the quotient are given by a logic 1 bit followed by at least one logic 0 bit, and if the t leading bits of Rᵢ are all logic 1 bits, then the predicted bits of the quotient are given by a logic 0 bit followed by at least one logic 1 bit.

6. The integrated circuit of claim 3 the partial remainder is estimated based on two most significant bits of the partial remainder and an additional bit of the partial remainder which is selected depending on the given stage.

7. The integrated circuit of claim 6 when the two most significant bits and the additional bit of the partial remainder are all logic 1 bits or all logic 0 bits, computations are skipped for at least two subsequent stages.

8. The integrated circuit of claim 1 wherein the divider circuitry comprises:
a remainder register;
a first counter; and
a first multiplexer configured to select a particular one of a plurality of lower order bit outputs of the remainder register responsive to a first count signal from the first counter;
wherein a number of subsequent stages for which computations can be skipped is determined based on one or more higher order bit outputs of the remainder register and at least one particular selected lower order bit output of the remainder register.

9. The integrated circuit of claim 8 wherein the divider circuitry further comprises:
a quotient register;
a second counter operative to generate a second count signal for selecting a particular bit position of the quotient register for updating to a predicted value in a corresponding one of the stages, wherein updating of the selected bit position is performed as a function of the first count signal from the first counter and a most significant bit output of the remainder register;
a second multiplexer configured to select a particular shifted version of outputs of the remainder register responsive to the first count signal from the first counter;
an exclusive-or gate having a first input adapted to receive a divisor and a second input coupled to the most significant bit output of the remainder register; and
an adder having a first input coupled to an output of the exclusive-or gate, a second input coupled to an output of the second multiplexer, and an output coupled to an input of the remainder register.

10. The integrated circuit of claim 8 wherein the first counter tracks a number of subsequent stages for which computations are skipped.

11. The integrated circuit of claim 9 further comprising a transparent latch coupled between an output of the first counter and a select line input of the second multiplexer, wherein the transparent latch and the remainder register are both controlled by a remainder register enable signal.

12. A method comprising:
configuring divider circuitry to iteratively determine bits of a quotient over multiple stages of computation; and
estimating a partial remainder for a given one of the stages; and
predicting one or more of the quotient bits for one or more subsequent stages based on the estimated partial remainder so as to allow one or more computations to be skipped for said one or more subsequent stages.

13. The method of claim 12 wherein the estimating step comprises estimating the partial remainder based on a position of a most significant bit of said partial remainder.

14. The method of claim 12 wherein the predicting step comprises determining a number of subsequent stages for which computations may be skipped as a function of the estimated partial remainder relative to a divisor.

15. The method of claim 12 wherein the partial remainder for stage i is denoted Rᵢ and the predicting step further comprises determining a number t of leading bits of Rᵢ that have the same logic value, and if t≧2 then predicting t-1 bits of the quotient.

16. A computer program product comprising a non-transitory computer-readable storage medium having computer program code embodied therein, wherein the computer program code when executed in a processing device causes the processing device to perform the steps of the method of claim 12.

17. A system comprising:
at least one processing device comprising at least one integrated circuit;
wherein the integrated circuit comprises divider circuitry configured to perform a division operation;
wherein said divider circuitry iteratively determines bits of a quotient over multiple stages of computation; and
wherein said divider circuitry is configured to estimate a partial remainder for a given one of the stages and to predict one or more of the quotient bits for one or more subsequent stages based on the estimated partial remainder so as to allow one or more computations to be skipped for said one or more subsequent stages.

18. The system of claim 17 comprising:
a plurality of processing devices including said at least one processing device; and
a network over which said processing devices communicate.

19. The system of claim 17 wherein said at least one processing device comprises a storage device.

20. The system of claim 19 wherein the storage device comprises a hard disk drive having read channel circuitry that incorporates said divider circuitry as part of a system-on-chip integrated circuit.
